(19) United States
(12) Patent Application Publication
(10) Pub. No.: US 2015/0270986 A1
(43) Pub. Date: Sep. 24, 2015

(54) CREDIT-BASED DYNAMIC BANDWIDTH ALLOCATION FOR TIME-DIVISION MULTIPLE ACCESS COMMUNICATIONS

(71) Applicants: Na WANG, (US); Patrick K.M. TSE, San Diego, CA (US); Honger NIE, San Diego, CA (US); Yue CAO, San Diego, CA (US); QUALCOMM INCORPORATED, San Diego, CA (US)

(72) Inventors: Na Wang, Shanghai (CN); Patrick Tse, Toronto (CA); Honger Nie, Beijing (CN); Yue Cao, Shanghai (CN)

(21) Appl. No.: 14/428,343

(22) PCT Filed: Oct. 29, 2012
(86) PCT No.: PCT/CN2012/083688

§ 371 Date: Mar. 13, 2015

(51) Int. Cl. H04L 12/403; H04L 12/873; H04L 12/927; H04L 12/801; H04L 12/911

(52) U.S. Cl. CPC H04L 12/4035; H04L 47/39; H04L 47/828; H04L 47/805; H04L 47/522; H04L 47/801

(57) ABSTRACT

A master device coupled to multiple slave devices in a system performs a method of allocating bandwidth. In the method, credits are assigned to each device of a plurality of devices in the system. Bandwidth is allocated among the plurality of devices for high-priority traffic, regardless of the credits. After allocating bandwidth for high-priority traffic, bandwidth is allocated among the plurality of devices based on the credits. A transmission schedule is generated for the plurality of devices based on the allocated bandwidth.

### TECHNICAL FIELD

The present embodiments relate generally to communication systems, and specifically to bandwidth allocation in networks that use time-division multiple access (TDMA).

### BACKGROUND OF RELATED ART

A system in which a master device is coupled to multiple slave devices may be implemented using a Time-Division Multiple Access (TDMA) protocol, such that access to the medium coupling the devices is time-multiplexed among the devices. For example, the master device receives reports from respective slave devices that specify how much traffic is queued for transmission in the respective slave devices. The master device then dynamically allocates bandwidth among the slave devices based in part on the reports. There is a need for efficient and effective dynamic bandwidth allocation techniques.

### BRIEF DESCRIPTION OF THE DRAWINGS

The present embodiments are illustrated by way of example and are not intended to be limited by the figures of the accompanying drawings.

FIG. 1 is a block diagram of a system with coax links in accordance with some embodiments.

FIG. 2A illustrates a sequence of beacon periods in accordance with some embodiments.

FIG. 2B illustrates time slots in a beacon period in accordance with some embodiments.

FIG. 3 is a block diagram of a master device coupled to a plurality of slave devices in accordance with some embodiments.

FIG. 4 is a flowchart illustrating a dynamic bandwidth allocation method performed by a master device coupled to a plurality of slave devices in a system in accordance with some embodiments.

FIG. 5 is a flowchart illustrating a method of assigning assured credits and peak credits in accordance with some embodiments.

FIG. 6 is a flowchart illustrating a method of allocating bandwidth for system operation overhead in accordance with some embodiments.

FIG. 7 is a flowchart illustrating a method of allocating bandwidth for high-priority traffic regardless of assigned credits in accordance with some embodiments.

FIG. 8 is a flowchart illustrating a method of allocating bandwidth based on assured credits in accordance with some embodiments.

FIG. 9 is a flowchart illustrating a method of allocating bandwidth based on peak credits in accordance with some embodiments.

FIG. 10A is a flowchart illustrating a method of allocating remaining bandwidth among devices that have queued traffic for which bandwidth has not already been allocated in accordance with some embodiments.

FIG. 10B is a flowchart illustrating a method of dividing remaining bandwidth among devices in accordance with some embodiments.

FIGS. 11A and 11B are flowcharts illustrating methods of generating a transmission schedule in accordance with some embodiments.

FIG. 12A is a block diagram of a master device in accordance with some embodiments.

FIG. 12B is a block diagram of a slave device in accordance with some embodiments.

Like reference numerals refer to corresponding parts throughout the drawings and specification.

### DETAILED DESCRIPTION

Embodiments are disclosed in which bandwidth is dynamically allocated among devices partially based on credits assigned to the devices and partially in a manner independent of the credits.

In some embodiments, a master device coupled to multiple slave devices in a system performs a method of allocating bandwidth. In the method, credits are assigned to each device of a plurality of devices in the system. Bandwidth is allocated among the plurality of devices for high-priority traffic, regardless of the credits. After allocating bandwidth for high-priority traffic, bandwidth is allocated among the plurality of devices based on the credits. A transmission schedule is generated for the plurality of devices based on the allocated bandwidth.

In some embodiments, a master device is to be coupled to a plurality of slave devices in a system. The master device includes a scheduler to assign credits to each device of a plurality of devices in the system; to allocate bandwidth among the plurality of devices for high-priority traffic, regardless of the credits; to allocate bandwidth among the plurality of devices based on the credits, after allocating bandwidth for high-priority traffic; and to generate a transmission schedule for the plurality of devices based on the allocated bandwidth. The master device also includes a physical-layer device (PHY) to transmit the transmission schedule.

In some embodiments, a non-transitory computer-readable storage medium stores one or more programs configured to be executed by a master device in a system comprising the master device and a plurality of slave devices. The one or more programs include instructions to assign credits to each device of a plurality of devices in the system; instructions to allocate bandwidth among the plurality of devices for high-priority traffic, regardless of the credits; instructions to allocate bandwidth among the plurality of devices based on the credits, after allocating bandwidth for high-priority traffic; and instructions to generate a transmission schedule for the plurality of devices based on the allocated bandwidth.

In some embodiments, a system includes a master device coupled to a plurality of slave devices. The master device includes a scheduler to assign credits to each device of a plurality of devices in the system; to allocate bandwidth among the plurality of devices for high-priority traffic, regardless of the credits; to allocate bandwidth among the plurality of devices based on the credits, after allocating bandwidth for high-priority traffic; and to generate a transmission schedule for the plurality of devices based on the allocated bandwidth. The master device further includes a PHY to transmit the transmission schedule to the plurality of slave devices. The plurality of slave devices is configured to transmit in accordance with the transmission schedule.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

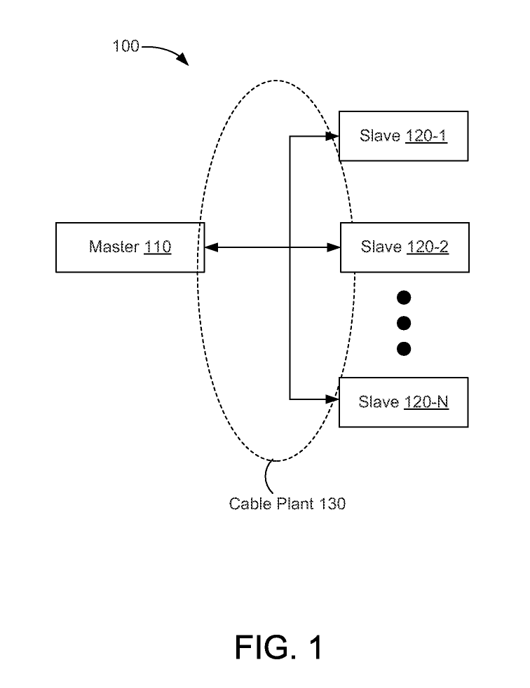

FIG. 1 illustrates a system (e.g., an access network) 100 in which a master device 110 is coupled to multiple slave devices 120-1 through 120-N, where N is an integer greater than one, in accordance with some embodiments. In some embodiments, the master device 110 is coupled to the slave devices 120-1 through 120-N using coaxial cable (“coax”) links that compose a cable plant 130. For example, the system 100 may be an Ethernet over Coax (EoC) access network. In some embodiments, the system 100 may be implemented in accordance with the HomePlug AV/IEEE1901 standard (e.g., as adapted for use with a coax medium). Transmissions from the master device 110 to the slave devices 120-1 through 120-N are referred to as downstream traffic and transmissions from respective slave devices 120-1 through 120-N to the master device 110 are referred to as upstream traffic. A respective slave device 120 may be associated with a respective user or account. Alternatively, a group of slave devices 120 (e.g., in the same home or office) may be associated with a respective user account.

Access to the medium (e.g., the coax links of the cable plant 130) that couples that devices 110 and 120-1 through 120-N is time-multiplexed using a Time-Division Multiple Access (TDMA) protocol. In some embodiments, the master device 110 periodically broadcasts a medium access schedule (also referred to as a channel access schedule) to all slave devices 120-1 through 120-N. For example, the channel access schedule is periodically broadcast in a message called a beacon message or simply a beacon. The channel access schedule assigns dedicated time slots to respective slave devices 120, such that a respective slave device 120 may transmit during its dedicated time slot and not during time slots assigned to other slave devices 120. A scheduler in the master device 110 determines the amount of medium access for each slave device 120 (or each group of slave devices 120), based for example on the service level agreements (SLAs) between end users associated with respective slave devices 120 and the service provider (e.g., cable operator) who controls the master device 110. The service level agreements specify amounts of bandwidth available to the slave devices 120. For example, a service level agreement may specify an assured bandwidth, which is an amount of bandwidth guaranteed to a slave device 120, and a peak bandwidth, which is greater than or equal to the peak bandwidth and is a maximum amount of bandwidth for a slave device 120. The scheduler constructs the channel access schedule based on the determined amounts of medium access for the slave devices 120.

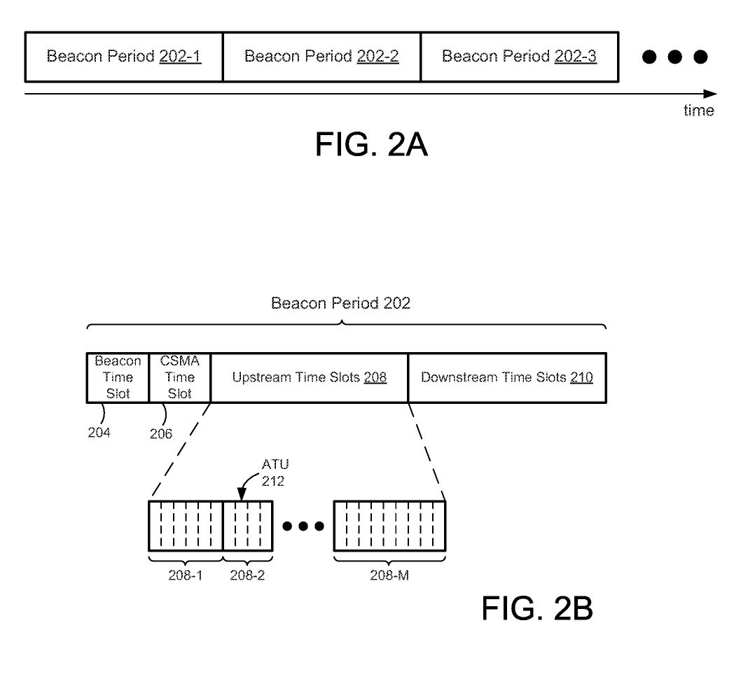

The period between broadcasts of successive channel access schedules (e.g., the period from the beginning of a beacon message to the beginning of the next beacon message) is called a beacon period. FIG. 2A illustrates a sequence of beacon periods in accordance with some embodiments: a first beacon period 202-1 is followed by a second beacon period 202-2, which is followed in turn by a third beacon period 202-3. Each beacon period 202 is divided into different time slots, as shown in FIG. 2B in accordance with some embodiments. A first time slot 204 is allocated for transmission of the beacon message and thus for transmission of the channel access schedule. A second time slot 206 is a contention-based time slot in which the slave devices 120-1 through 120-N may compete for transmission bandwidth in accordance with a carrier-sense multiple access (CSMA) protocol. For example, newly activated slave devices 120 may compete to use the contention-based time slot 206 to register with the master device 110. In some embodiments, the contention-based time slot 206 is not included in every beacon period 202, but instead is only included in a portion of the beacon periods 202.

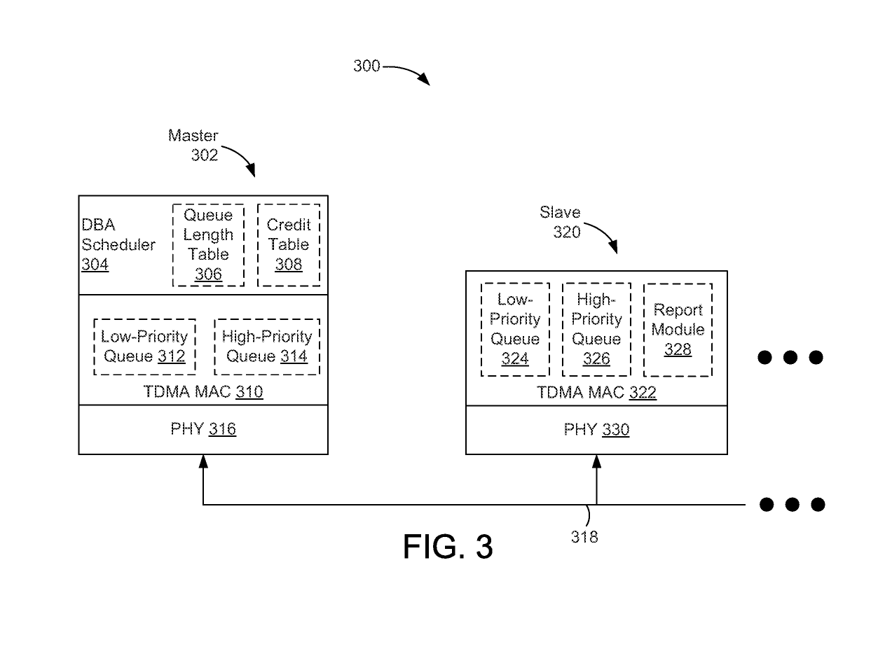

Each beacon period 202 further includes upstream time slots 208 and downstream time slots 210. The time slots 208 and 210 are allocated in accordance with a time-division multiple access (TDMA) protocol. Respective upstream time slots 208 are assigned to respective slave devices 120 for upstream transmissions to the master device 110. These assignments are based at least in part on the reported status of transmission queues in the slave devices 120. (These assignments may be further based on service level agreements and on the modulation and coding schemes used for respective links, as specified by respective tone maps.) For example, a slave device 120 may have multiple queues (e.g., low-priority queue 324 and high-priority queue 326, FIG. 3), each of which buffers upstream traffic of a given priority (e.g., low priority or high priority). When an upstream time slot 208 is assigned to a specific slave device 120, traffic buffered in one or more queues of that slave device 120 may be transmitted upstream to the master device 110 during the time slot 208. A first upstream time slot 208-1 thus may be assigned to a first slave device 120-1, a second upstream time slot 208-2 may be assigned to a second slave device 120-2, and so on. In some embodiments, each slave device 120 determines how to allocate time in an assigned time slot 208 among its queues. A total of M upstream time slots 208 are assigned to M slave devices 120, where M is the number of slave devices 120 allowed to transmit during a respective beacon period 202. The number M may vary from beacon period 202 to beacon period 202, depending for example on the available bandwidth and demand for bandwidth during different beacon periods 202.

Downstream time slots 210 are allocated for downstream transmissions by the master device 110. The downstream time slots 210 may include time slots for unicast transmissions to specific slave devices 120 as well as a time slot for broadcasts to all of the slave devices 120-1 through 120-N. The downstream time slots 210 may be allocated based at least in part on downstream traffic queued in the master device 110, and also based on service level agreements and the modulation and coding schemes used for respective links, as specified by respective tone maps. Because the downstream time slots 210 are allocated to the master device 110, the slave devices 120 do not transmit during the downstream time slots 210.

The lengths (i.e., durations) of the time slots 204, 206, 208, and/or 210 are variable, as shown for the time slots 208-1, 208-2, and 208-M in FIG. 2B. For example, the scheduler in the master device 110 assigns upstream time slots 208 of different lengths to different slave devices 120, in accordance with a dynamic bandwidth allocation (DBA) algorithm. The time slots 204, 206, 208, and 210 are divided into fixed-length allocation time units (ATUs) 212, such that each time slot is an integer number of ATUs 212. An ATU 212 is thus the unit of time for specifying the length of a time slot. In some embodiments (e.g., in accordance with the HomePlug AV/IEEE 1901 standard), an ATU 212 is 10.24 us. The beacon message specifies the length of each time slot by specifying the number of ATUs 212 assigned to each time slot. For example, respective fields in the beacon message contain bits specifying the number of ATUs 212 for respective time slots. The bits specifying the number of ATUs 212 for a respective time slot may be spread over more than one field in the beacon message (e.g., may be divided between two fields). Also, a respective field may include a first set of bits for a first time slot and a second set of bits for a second time slot.

In each beacon period 202 (e.g., during respective upstream time slots 208), the slave devices 120-1 through 120-N report their amounts of queued upstream traffic to the master device 110 so that the master device 110 can create an appropriate channel access schedule for a subsequent (e.g., the next) beacon period 202. The amount of queued upstream traffic for a respective slave device 120 may include the amount of low-priority traffic queued for upstream transmission in the slave device 120 and the amount of high-priority traffic queued for upstream transmission in the slave device 120. The channel access schedule for the subsequent (e.g., next) beacon period 202 assigns upstream time slots 208 based at least in part on the reported amounts of queued upstream traffic.

FIG. 3 illustrates a system 300 in which a master device 302 is coupled to a plurality of slave devices 320 by a coax medium 318 in accordance with some embodiments. The system 300 is an example of the system 100 (FIG. 1): the master device 302 is an example of the master device 110 (FIG. 1) and each slave device 320 is an example of a slave device 120 (FIG. 1). The master device 302 includes a physical-layer device (PHY) 316 (e.g., a HomePlug AV PHY) to transmit and receive signals (e.g., OFDM signals) over the coax medium 318, a TDMA media access controller (MAC) 310 coupled to the PHY 316, and a dynamic bandwidth allocation (DBA) scheduler 304 coupled to the TDMA MAC 310. Each slave device 320 includes a PHY 330 (e.g., a HomePlug AV PHY) to transmit and receive signals (e.g., OFDM signals) over the coax medium 318 and a TDMA MAC 322 coupled to the PHY 330.

The TDMA MAC 322 of the slave device 320 includes a low-priority queue 324 to store low-priority traffic (e.g., low-priority packets) for subsequent upstream transmission to the master device 302 and a high-priority queue 326 to store high-priority traffic (e.g., high-priority packets) for subsequent upstream transmission to the master device 302. The terms low-priority and high-priority as used herein are used with respect to each other: low-priority traffic has lower priority than high-priority traffic, and vice versa. In some embodiments, there are multiple types of high-priority traffic. For example, the high-priority traffic may include Voice-over-Internet-Protocol (VoIP) traffic and non-VoIP traffic. The TDMA MAC 322 also includes a report module 328 that monitors the status (e.g., the length, and thus the amount queued traffic) of the queues 324 and 326 and prepares reports for transmission to the master device 302 that report the status of the queues 324 and 326. The slave device 320 transmits these reports to the master device 302 during upstream time slots 208 (FIG. 2B).

The TDMA MAC 310 of the master device 302 includes a low-priority queue 312 to store low-priority downstream traffic for subsequent transmission and a high-priority queue 314 to store high-priority downstream traffic for subsequent transmission. In some embodiments, the TDMA MAC 310 includes a separate low-priority queue 312 and high-priority queue 314 for each slave device 320.

The DBA scheduler 304 of the master device 302 includes a queue length table 306 to track the status of the queues 324 and 326 as reported by the slave devices 320 and also to track the status of the queues 312 and 314 in the master device 302. The DBA scheduler 304 also includes a credit table 308 to track credits assigned to respective devices (e.g., respective slave devices 320 and/or the master device 302) in the system 300. These credits are used to implement service level agreements. For example, the credits include assured credits and peak credits, which correspond respectively to the assured bandwidth and peak bandwidth specified in the service level agreements.

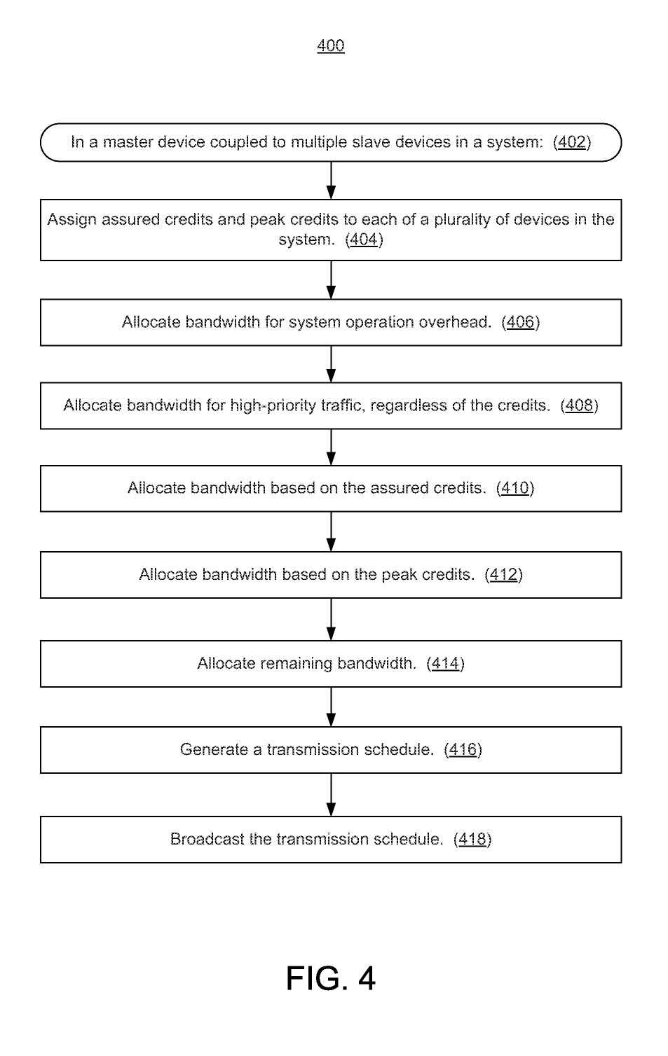

FIG. 4 is a flowchart illustrating a dynamic bandwidth allocation method 400 performed (402) by the master device 302, as coupled to the slave devices 320 in the system 300 (FIG. 3), in accordance with some embodiments.

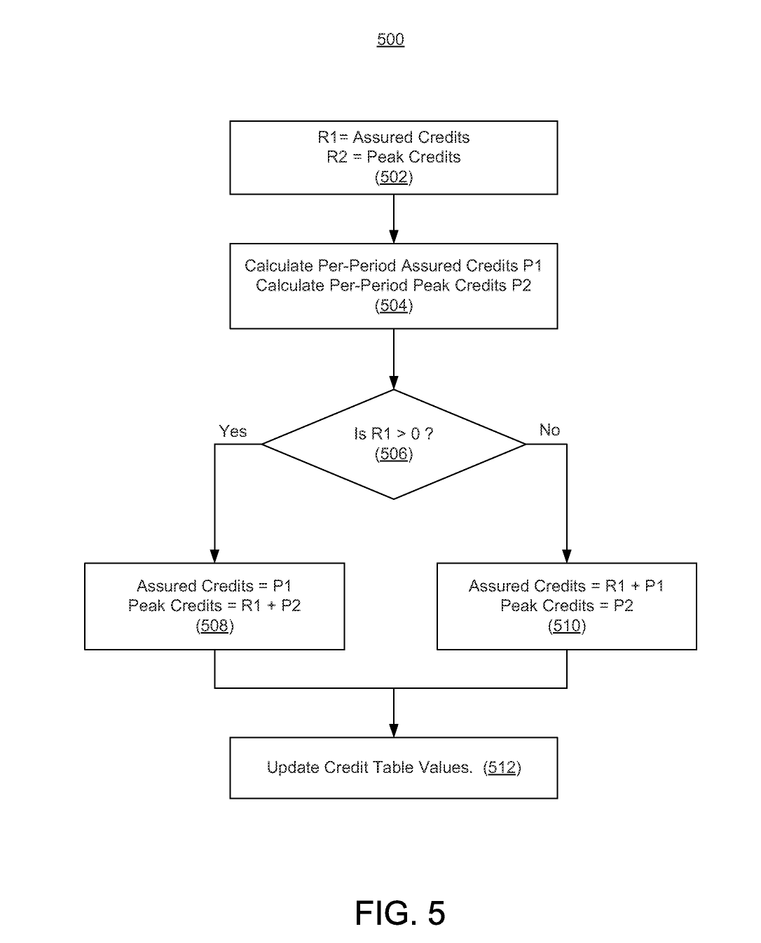

In the method 400, the DBA scheduler 304 assigns (404) assured credits and peak credits to each of a plurality of devices in the system 300. The plurality of devices to which the credits are assigned include active slave devices 320 (e.g., slave devices 320 that are turned on and have completed an association and authentication process with the master device 302) and may also include the master device 302. An example of credit assignment 404 is provided below in the method 500 of FIG. 5.

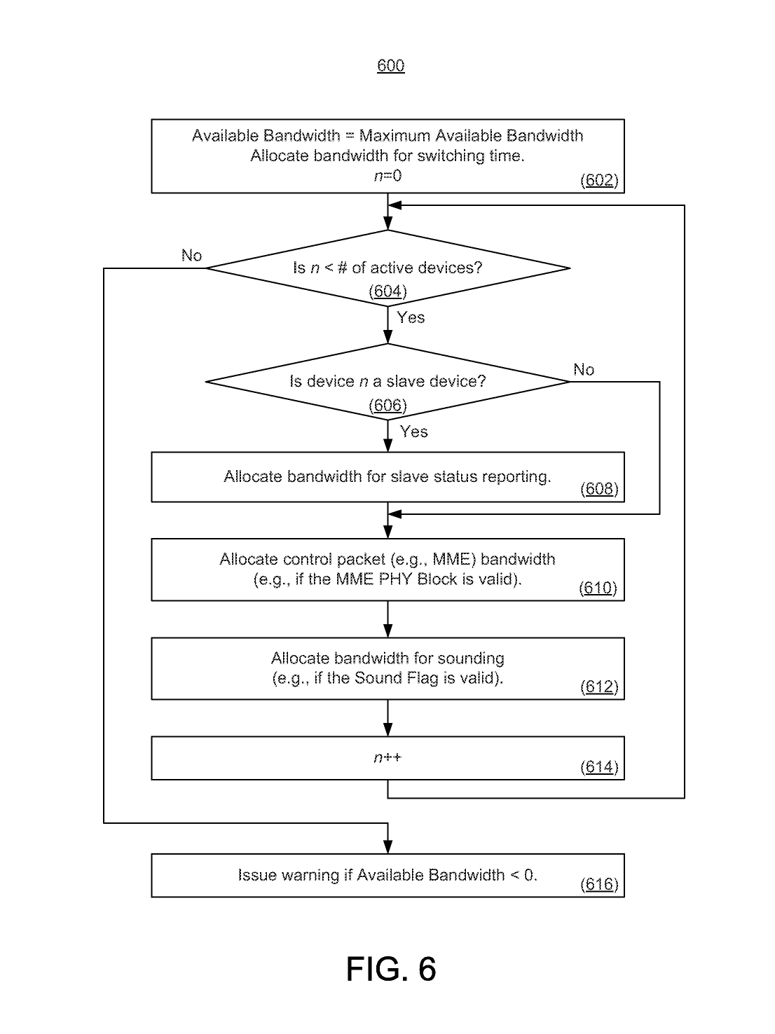

The DBA scheduler 304 allocates (406) bandwidth for overhead associated with operation of the system 300. An example of overhead bandwidth allocation 406 is provided below in the method 600 of FIG. 6.

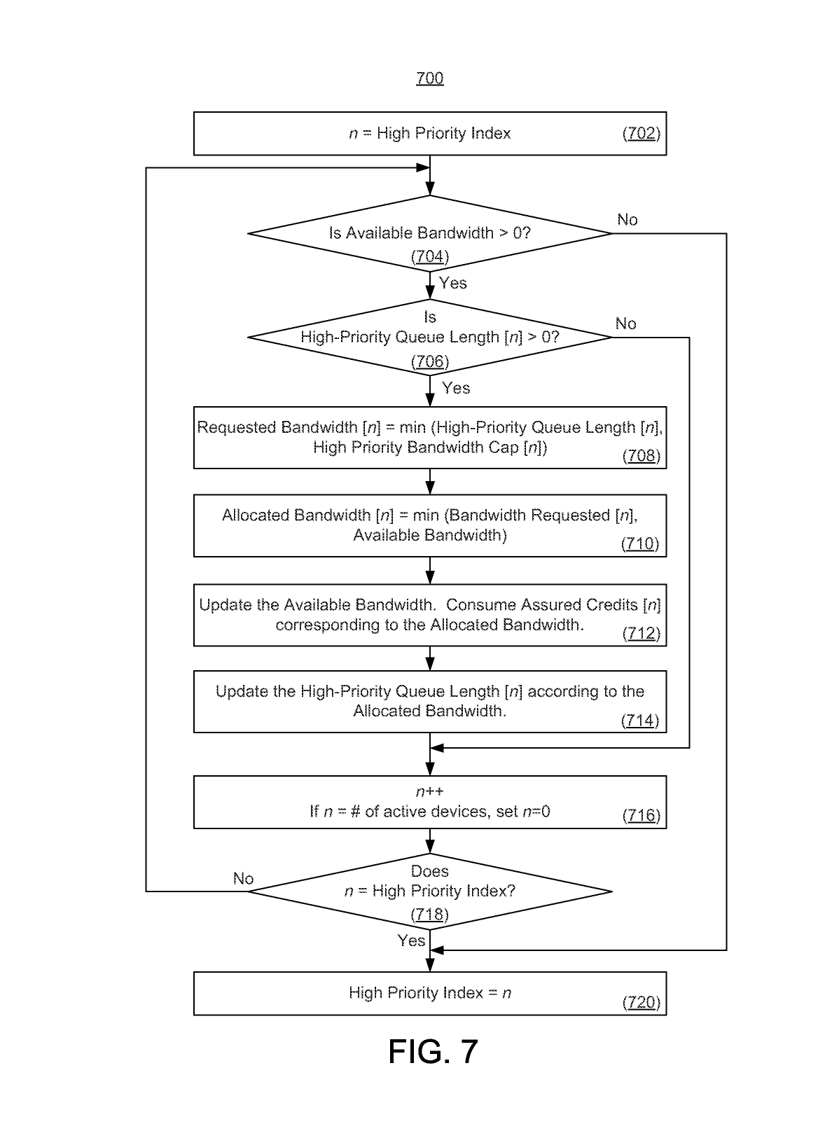

The DBA scheduler 304 allocates (408) bandwidth for high-priority traffic, regardless of the credits assigned in the operation 404. The assured credits and peak credits thus do not limit the amount of bandwidth allocated in the operation 408, although credits (e.g., assured credits) may be consumed, such that the credits (e.g., the assured credits) for a respective device are reduced by the amount of bandwidth allocated to the respective device for high-priority traffic. In some embodiments, high-priority traffic includes multiple types of traffic and the operation 408 is performed for a first type of high-priority traffic (e.g., for VoIP traffic). An example of the allocation 408 of bandwidth for high-priority traffic is provided below in the method 700 of FIG. 7.

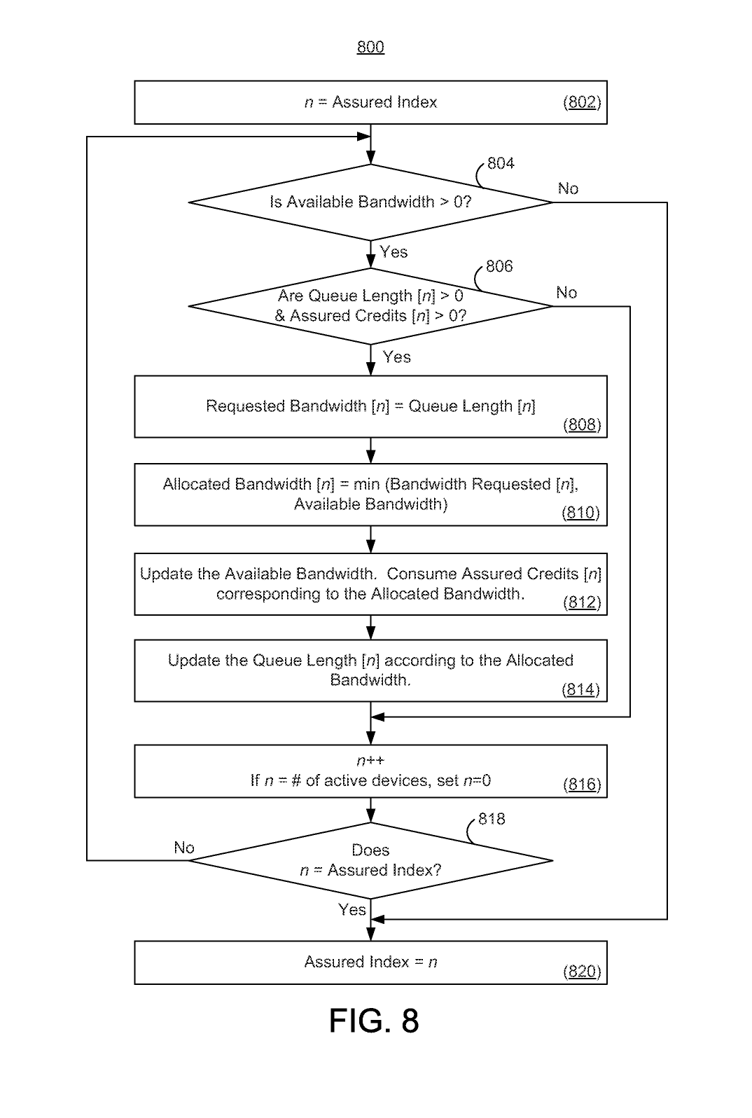

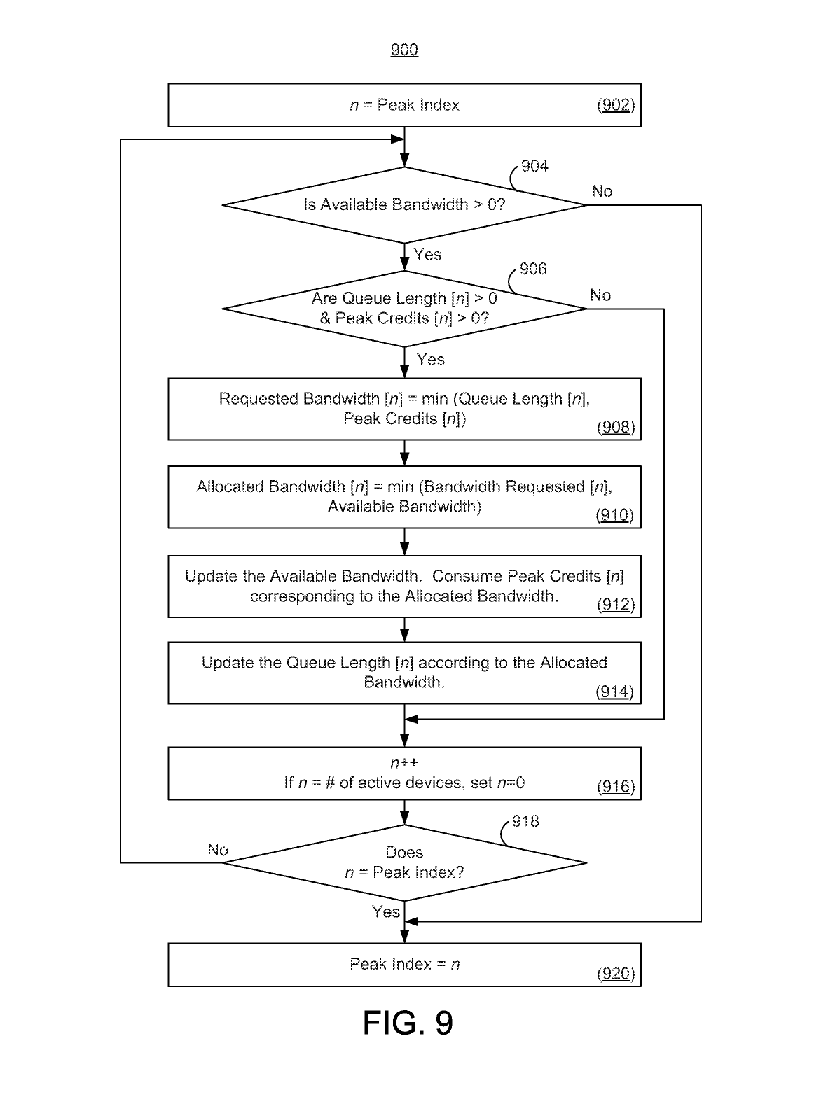

After allocating (408) bandwidth for high-priority traffic, the DBA scheduler 304 allocates bandwidth among the plurality of devices based on the credits assigned in the operation 404. For example, the DBA scheduler 304 allocates (410) bandwidth based on the assured credits and then allocates (412) bandwidth based on the peak credits. An example of the allocation 410 of bandwidth based on the assured credits is provided below in the method 800 of FIG. 8. An example of the allocation 412 of bandwidth based on the peak credits is provided below in the method 900 of FIG. 9.

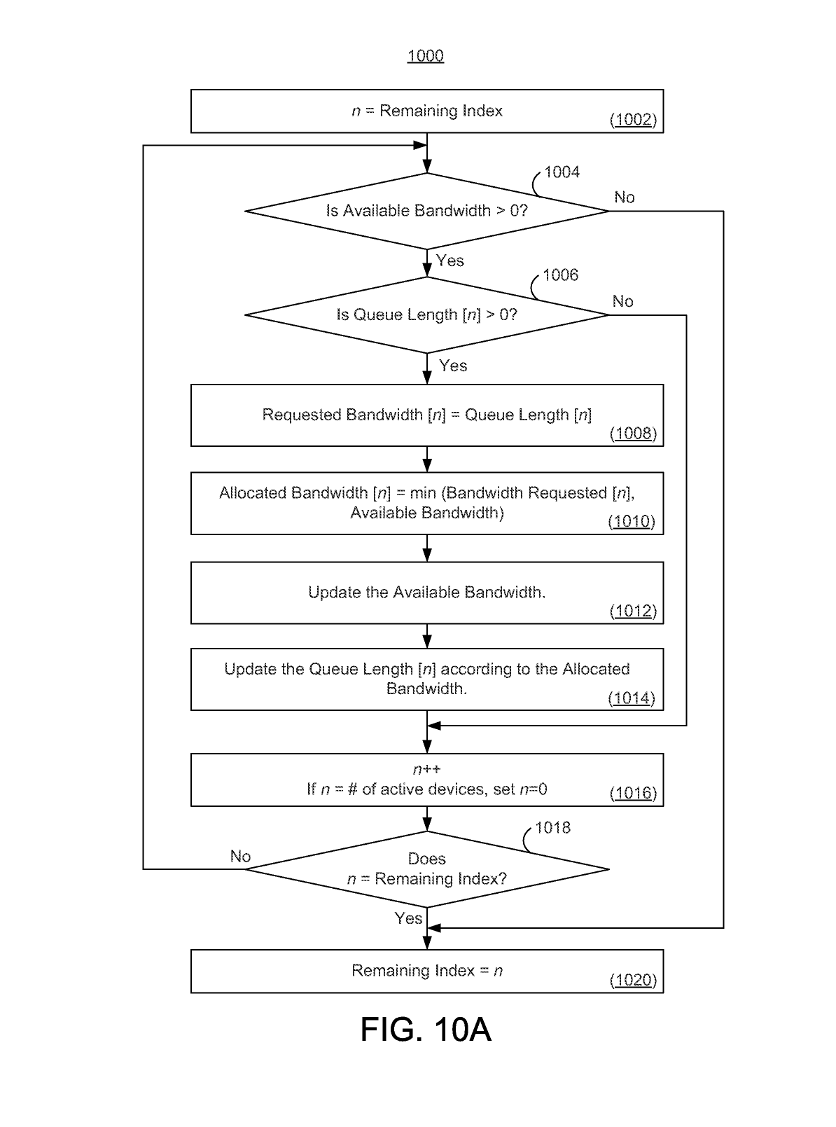

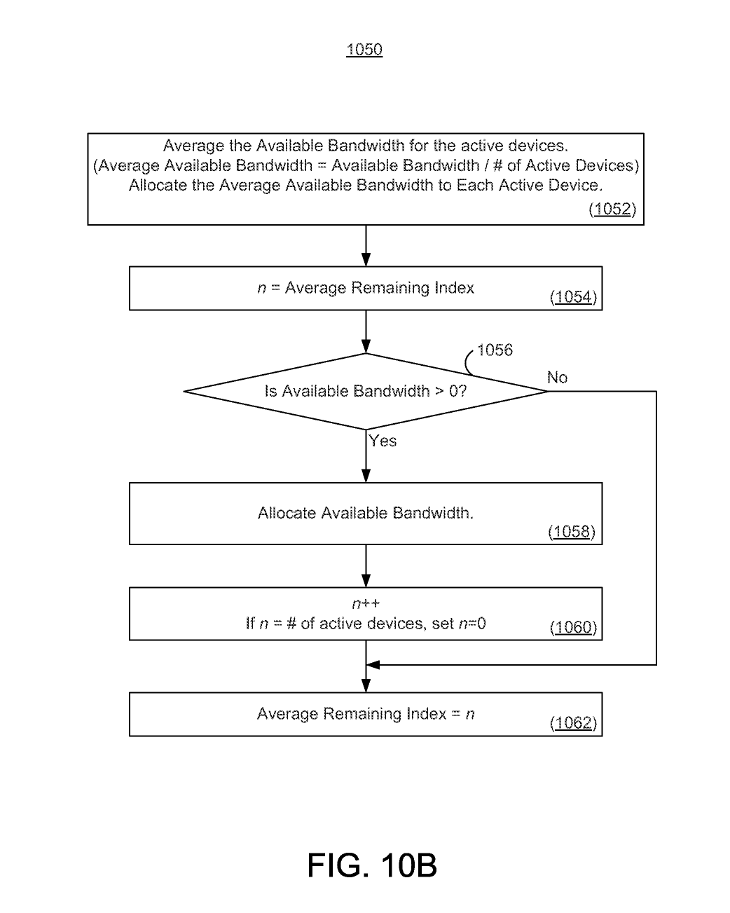

After allocating (412) bandwidth based on the peak credits, the DBA scheduler 304 allocates (414) remaining bandwidth. For example, bandwidth is allocated among respective devices that have queued traffic for which bandwidth has not already been allocated in previous operations of the method 400. Any remaining bandwidth is divided (e.g., equally) among the plurality of devices. An example of allocating bandwidth among respective devices that have queued traffic for which bandwidth has not previously been allocated is provided below in the method 1000 of FIG. 10A. An example of dividing remaining bandwidth among the plurality of devices is provided below in the method 1050 of FIG. 10B.

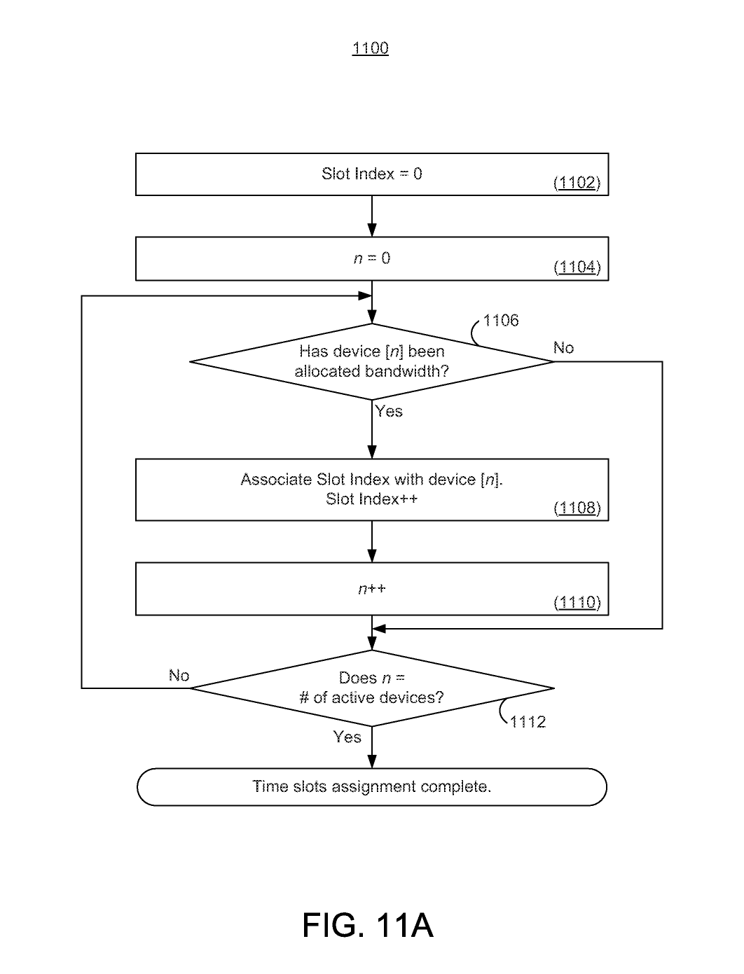

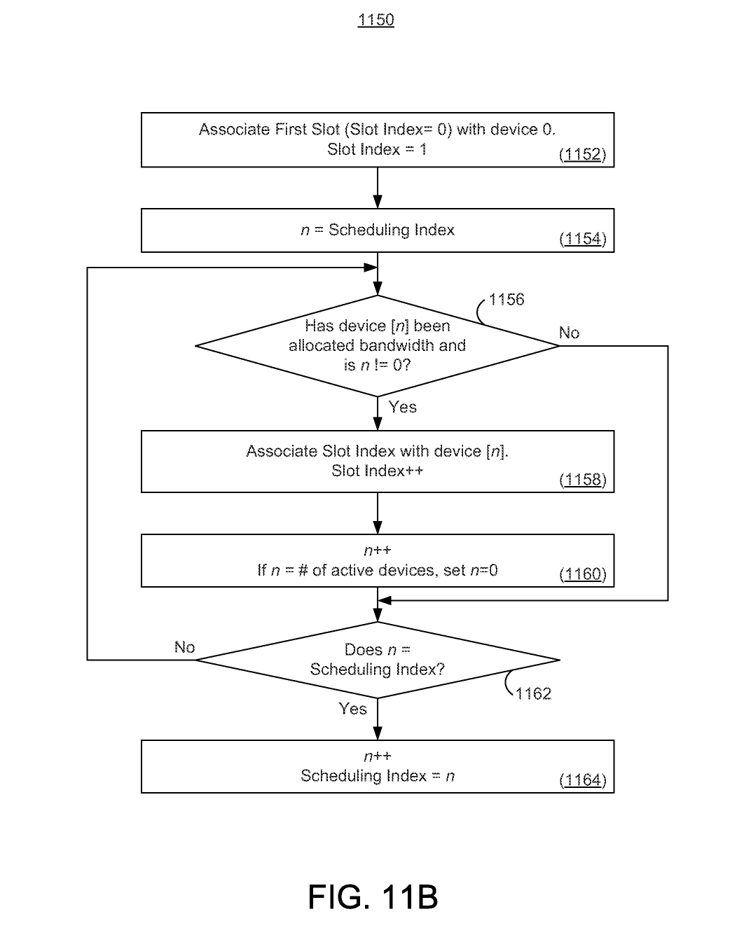

Once the bandwidth allocation is complete, the DBA scheduler 304 generates (416) a transmission schedule. Examples of generating a transmission schedule are provided below in the method 1100 of FIG. 11A and the method 1150 of FIG. 11B. The DBA scheduler determines the lengths of time slots 408 and 410 to be assigned to respective devices based on the bandwidth allocated to the respective devices. The transmission schedule is broadcast (418) to the plurality of devices (e.g., in a beacon message during a time slot 204, FIG. 2B).

The method 400 is repeated periodically. For example, the operations 406-418 are performed in each beacon period 202 (FIG. 2A). The assignment of credits 404 may also be performed in each beacon period 202, or alternatively is performed with a periodicity corresponding to a predefined number of beacon periods 202. The time period between iterations of the assignment of credits 404 is referred to as a credit period and may be configurable.

In some embodiments, the method 400 is performed repeatedly during a single time period (e.g., a single beacon period 202, FIG. 2), with each performance being for a different class of users. For example, during a single beacon period 202 the method 400 may be performed first for VIP users and then for regular users.

FIG. 5 is a flowchart illustrating a method 500 of assigning assured credits and peak credits in accordance with some embodiments. The method 500 is an example of the operation 404 (FIG. 4). The method 500 is performed by the DBA scheduler 304 in the master device 302 (FIG. 3) for respective devices or groups of devices in the system 300 (e.g., for the master device 302 and active slave devices 320, FIG. 3), and is performed periodically to refresh the credits for each of the respective devices or groups of devices.

In the method 500, a variable R1 is set equal to the current number of assured credits for a device (or group of devices) and a variable R2 is set equal to the current number of peak credits for the device (502). A number of assured credits P1 and a number of peak credits P2 corresponding to a credit period are calculated (504). In some embodiments, the credits have units corresponding to a number of symbols. To calculate P1 and P2, the assured bandwidth and peak bandwidth as specified in the service level agreement for a device or group of devices (e.g., with units of kbps) are multiplied by the duration of the credit period. The resulting numbers of bits are then converted to corresponding numbers of OFDM symbols (e.g., in accordance with the relevant tone map).

A determination is made (506) as to whether R1 is positive. If R1 is positive (506-Yes), the number of assured credits is set equal to P1 and the number of peak credits is set equal to R1 plus P2 (508), such that unused assured credits from a previous credit period are converted to peak credits, and the number of assured credits is capped at P1. If R1 is negative or zero (506-No), the number of assured credits is set equal to R1 plus P1 and the number of peak credits is set equal to P2 (510). The device thus may have fewer than P1 assured credits if the device consumed an excessive number of assured credits (e.g., during the operation 408, FIG. 4) during a previous credit period.

The credit table 308 (FIG. 3) is updated (512) to reflect the results of operation 508 or 510, thus refreshing the credits for a respective device or group of devices.

FIG. 6 is a flowchart illustrating a method 600 of allocating bandwidth for overhead associated with operation of the system 300 in accordance with some embodiments. The method 600 is an example of the operation 406 (FIG. 4) and may be performed by the DBA scheduler 304 of the master device 302 (FIG. 3).

The available bandwidth is set (602) equal to a maximum available bandwidth for the system 300. Bandwidth is allocated for switching between transmitting and receiving in the master device 302 (e.g., for a time gap associated with this switching; this gap is sometimes referred to as the last revisal gap). Each time bandwidth is allocated in the method 600, the available bandwidth is reduced accordingly. A variable n is set equal to zero. The variable n is used to index devices.

A determination is made (604) if n is less than the number of active devices (e.g., the number of active slave devices 320 plus the master device 302). The number of active devices is sometimes referred to as the number of active links. If n is not less than the number of active devices (604-No), then a warning is issued (616) if the available bandwidth is less than zero, which would mean that not enough bandwidth is available for system overhead, and the method 600 ends.

If n is less than the number of active devices (604-Yes), then a determination is made (606) if device n is a slave device 320. If it is (606-Yes), then bandwidth is allocated (608) for a reporting message to be transmitted by the device n. The reporting message reports the status of queues (e.g., low-priority queue 324 and high-priority queue 326, FIG. 3) in the device n. The time associated with reporting messages is sometimes referred to as a link revisal gap. If device n is not a slave device 320 (606-No), the allocation 608 is skipped: in this case, device n is the master device 302, which can monitor the status of its queues 312 and 314 internally.

Bandwidth is allocated (610) for control packets. In some embodiments, the control packets are Management Message Entries (MME) as defined, for example, in accordance with HomePlug AV/IEEE1901 standard and bandwidth is allocated for them if an MME PHY block in a respective device is set valid.

Bandwidth is allocated (612) for sounding if sounding is to be performed (e.g., as specified by a sounding flag in a respective device being set valid). The sounding process involves transmitting known data between the master device 302 and a slave device 320 and using the known data to estimate channel characteristics. A tone map specifying modulation and coding schemes for respective carriers is generated based on the estimated channel characteristics. Sounding may be performed separately for upstream and downstream transmissions between a master device 302 and slave device 320; bandwidth is allocated accordingly.

The variable n is incremented (“n++”) (614) such that it now indexes another device, and the method 600 returns to operation 604. The method 600 continues until bandwidth for system operation overhead for all active devices has been allocated. The allocated bandwidth for system operation overhead thus includes bandwidth for control packets (e.g., MME bandwidth), bandwidth for reporting messages from slave devices 320, bandwidth for switching time, and/or bandwidth for sounding.

FIG. 7 is a flowchart illustrating a method 700 of allocating bandwidth for high-priority traffic regardless of assigned credits in accordance with some embodiments. The method 700 is an example of the operation 408 (FIG. 4) and may be performed by the DBA scheduler 304 of the master device 302 (FIG. 3).

The variable n is set (702) equal to a variable “High Priority Index,” which is used to index devices in the system 300. A determination is made (704) if the available bandwidth is greater than zero. If not, (704-No), High Priority Index is set (720) equal to n and the method 700 ends. Setting High Priority Index equal to n in this situation ensures that the method 700 will begin with device n in the next iteration (e.g., in the next beacon period 202, FIG. 2A), which compensates for the fact that device n did not receive a bandwidth allocation during the current iteration of the method 700, because no bandwidth was available.

If the available bandwidth is greater than zero (704-Yes), then a determination is made (706) as to whether the length of the high-priority queue 326 or 314 (FIG. 3) for device n (or alternatively, whether a number of high-priority packets of a first type, for example, VoIP packets, in the high-priority queue) is greater than zero. If no (706-no), no bandwidth is allocated and the method 700 proceeds to operation 716, described below. If yes (706-yes), a requested bandwidth for device n (“Request Bandwidth [n]”) is determined (708) to be the minimum (i.e., the lessor) of bandwidth corresponding to the high-priority queue length for device n and a high-priority bandwidth cap. The high-priority bandwidth cap helps to prevent bandwidth starvation for traffic of other priorities (e.g., low-priority traffic and/or high-priority traffic of a second type, such as non-VoIP traffic). In some embodiments, the high-priority bandwidth cap is less than or equal to the assured bandwidth.

The minimum of the requested bandwidth for device n and the available bandwidth is allocated (710) to device n. The available bandwidth is updated (i.e., reduced) (712) accordingly. Assured credits for device n are consumed (712): the number of assured credits for device n is reduced by an amount corresponding to the allocated bandwidth. The allocation 710 of bandwidth for high-priority traffic thus is done regardless of credits: a lack of available credits does not prevent or limit the allocation 710. However, the allocation 710 consumes assured credits and thus may limit bandwidth allocated to the device n for other types of traffic. The number of assured credits for device n may become negative based on the consumption 712.

The high-priority queue length for device n, as tracked by the DBA scheduler 304 in the queue length table 306, is updated (i.e., reduced) (714) according to the bandwidth allocation 710. The variable n is incremented (716); if the incremented value of n equals the number of active devices, n is reset to zero, such that n wraps around. A determination is made (718) if n equals the High Priority Index. If no (718-no), the method 700 has not been completed for every active device and the method 700 returns to operation 704. If yes (718-yes), the method 700 has been completed for every active device, and the High Priority Index is set (720) equal to n, such that the method 700 will begin with the device n during a subsequent iteration.

FIG. 8 is a flowchart illustrating a method 800 of allocating bandwidth based on assured credits in accordance with some embodiments. The method 800 is an example of the operation 410 (FIG. 4) and may be performed by the DBA scheduler 304 of the master device 302 (FIG. 3). In some embodiments, the method 800 is performed twice in succession during a time period (e.g., a beacon period 202, FIG. 2), before execution of the method 900 (FIG. 9): the method 800 is first performed for high-priority traffic (e.g., of a second type, for example non-VoIP traffic) and is then performed again for low-priority traffic. Alternatively, bandwidth for high-priority traffic has already been allocated in the method 700 (FIG. 7) and the method 800 is performed once, for low-priority traffic.

The variable n is set (802) equal to a variable “Assured Index,” which is used to index devices in the system 300. A determination is made (804) if the available bandwidth is greater than zero. If not, (804-No), the Assured Index is set (820) equal to n and the method 800 ends. Setting the Assured Index equal to n in this situation ensures that the method 800 will begin with device n in the next iteration (e.g., in the next beacon period 202, FIG. 2A), which compensates for the fact that device n did not receive a bandwidth allocation during the current iteration of the method 800, because no bandwidth was available.

If the available bandwidth is greater than zero (804-Yes), then a determination is made (806) as to whether both the length of a queue (e.g., a high-priority queue 326 or 314, or alternatively a low-priority queue 324 or 312, FIG. 3) for device n and the number of assured credits for device n are greater than zero. If no (806-no), no bandwidth is allocated and the method 800 proceeds to operation 816, described below. If yes (806-yes), a requested bandwidth for device n (“Request Bandwidth [n]”) is determined (808) to be an amount of bandwidth corresponding to the queue length for device n. Alternatively, the requested bandwidth for device n is the minimum of an amount of bandwidth corresponding to the queue length and an amount of bandwidth corresponding to the number of assured credits for the device n.

The minimum of the requested bandwidth for device n and the available bandwidth is allocated (810) to device n. The available bandwidth is updated (i.e., reduced) (812) accordingly. Assured credits for device n are consumed (812): the number of assured credits for device n is reduced by an amount corresponding to the allocated bandwidth.

The relevant queue length for device n, as tracked by the DBA scheduler 304 in the queue length table 306, is updated (i.e., reduced) (814) according to the bandwidth allocation 810. The variable n is incremented (816); if the incremented value of n equals the number of active devices, n is reset to zero, such that n wraps around. A determination is made (818) if n equals the Assured Index. If no (818-no), the method 800 has not been completed for every active device and the method 800 returns to operation 804. If yes (818-yes), the method 800 has been completed for every active device, and the Assured Index is set (820) equal to n, such that the method 800 will begin with the device n during a subsequent iteration.

FIG. 9 is a flowchart illustrating a method 900 of allocating bandwidth based on peak credits in accordance with some embodiments. The method 900 is an example of the operation 412 (FIG. 4) and may be performed by the DBA scheduler 304 of the master device 302 (FIG. 3). In some embodiments, the method 900 is performed twice in succession during a time period (e.g., a beacon period 202, FIG. 2), before execution of the methods 1000 and/or 1050 (FIGS. 10A-10B): the method 900 is first performed for high-priority traffic (e.g., of a second type, for example non-VoIP traffic) and is then performed again for low-priority traffic. Alternatively, bandwidth for high-priority traffic has already been allocated in the method 700 (FIG. 7) and the method 900 is performed once, for low-priority traffic.

The variable n is set (902) equal to a variable “Peak Index,” which is used to index devices in the system 300. A determination is made (904) if the available bandwidth is greater than zero. If not, (904-No), the Peak Index is set (920) equal to n and the method 900 ends. Setting the Peak Index equal to n in this situation ensures that the method 900 will begin with device n in the next iteration (e.g., in the next beacon period 202, FIG. 2A), which compensates for the fact that device n did not receive a bandwidth allocation during the current iteration of the method 900, because no bandwidth was available.

If the available bandwidth is greater than zero (904-Yes), then a determination is made (906) as to whether both the length of a queue (e.g., a high-priority queue 326 or 314, or alternatively a low-priority queue 324 or 312, FIG. 3) for device n and the number of peak credits for device n are greater than zero. If no (906-no), no bandwidth is allocated and the method 900 proceeds to operation 916, described below. If yes (906-yes), a requested bandwidth for device n (“Request Bandwidth [n]”) is determined (908) to be the minimum of an amount of bandwidth corresponding to the queue length for device n and an amount of bandwidth corresponding to the number of peak credits for the device n.

The minimum of the requested bandwidth for device n and the available bandwidth is allocated (910) to device n. The available bandwidth is updated (i.e., reduced) (912) accordingly. Peak credits for device n are consumed (912): the number of peak credits for device n is reduced by an amount corresponding to the allocated bandwidth.

The relevant queue length for device n, as tracked by the DBA scheduler 304 in the queue length table 306, is updated (i.e., reduced) (914) according to the bandwidth allocation 910. The variable n is incremented (916); if the incremented value of n equals the number of active devices, n is reset to zero, such that n wraps around. A determination is made (918) if n equals the Peak Index. If no (918-no), the method 900 has not been completed for every active device and the method 900 returns to operation 904. If yes (918-yes), the method 900 has been completed for every active device, and the Peak Index is set (920) equal to n, such that the method 900 will begin with the device n during a subsequent iteration.

If any available bandwidth remains after performance of the methods 600, 700, 800, and 900 (FIGS. 6-9) for a respective time period (e.g., a respective beacon period 202, FIG. 2A), the remaining bandwidth is allocated among the active device. This allocation may be done regardless of the assured and peak credits for respective devices and without consuming any credits. In some embodiments, this allocation may be done in multiple steps, first based on queued traffic for which bandwidth has not already been allocated and then by dividing up any remaining bandwidth, in accordance with some embodiments.

FIG. 10A is a flowchart illustrating a method 1000 of allocating remaining bandwidth among devices that have queued traffic for which bandwidth has not already been allocated in accordance with some embodiments. The method 1000 is an example of at least a portion of the operation 414 (FIG. 4) and may be performed by the DBA scheduler 304 of the master device 302 (FIG. 3). In some embodiments, the method 1000 is performed twice in succession for a time period (e.g., a beacon period 202, FIG. 2), assuming any bandwidth remains: the method 1000 is first performed for high-priority traffic (e.g., of a second type, for example non-VoIP traffic) and is then performed again for low-priority traffic. Alternatively, bandwidth for high-priority traffic has already been allocated in the method 700 (FIG. 7) and the method 1000 is performed once, for low-priority traffic.

The variable n is set (1002) equal to a variable “Remaining Index,” which is used to index devices in the system 300. A determination is made (1004) if the available bandwidth is greater than zero. If not, (1004-No), the Remaining Index is set (1020) equal to n and the method 1000 ends. Setting the Remaining Index equal to n in this situation ensures that the method 1000 will begin with device n in the next iteration (e.g., in the next beacon period 202, FIG. 2A), which compensates for the fact that device n did not receive a bandwidth allocation during the current iteration of the method 1000, because no bandwidth was available.

If the available bandwidth is greater than zero (1004-Yes), then a determination is made (1006) as to whether the length of a queue (e.g., a high-priority queue 326 or 314, or a low-priority queue 324 or 312, FIG. 3) for device n is greater than zero. If no (1006-no), no bandwidth is allocated and the method 1000 proceeds to operation 1016, described below. If yes (1006-yes), a requested bandwidth for device n (“Request Bandwidth [n]”) is determined (1008) to be an amount of bandwidth corresponding to the queue length for device n.

The minimum of the requested bandwidth for device n and the available bandwidth is allocated (1010) to device n. The available bandwidth is updated (i.e., reduced) (1012) accordingly. The allocation 1010 is done regardless of the numbers of assured and peak credits for the device n and no credits are consumed.

The relevant queue length for device n, as tracked by the DBA scheduler 304 in the queue length table 306, is updated (i.e., reduced) (1014) according to the bandwidth allocation 1010. The variable n is incremented (1016); if the incremented value of n equals the number of active devices, n is reset to zero, such that n wraps around. A determination is made (1018) if n equals the Remaining Index. If no (1018-no), the method 1000 has not been completed for every active device and the method 1000 returns to operation 1004. If yes (1018-yes), the method 1000 has been completed for every active device, and the Remaining Index is set (1020) equal to n, such that the method 1000 will begin with the device n during a subsequent iteration.

FIG. 10B is a flowchart illustrating a method 1050 of dividing remaining bandwidth among devices in accordance with some embodiments. The method 1050 is an example of at least a portion of the operation 414 (FIG. 4) and may be performed by the DBA scheduler 304 of the master device 302 (FIG. 3).

The remaining available bandwidth is averaged (1052) among the active devices. For example, the available bandwidth is divided evenly among the active devices, such that the average available bandwidth equals the available bandwidth divided by the number of active devices. Each active device is allocated the average available bandwidth.

After allocation of the average available bandwidth to the devices, some available bandwidth may remain due to round-off when averaging. To allocate this remaining bandwidth, the variable n is set (1054) equal to a variable “Average Remaining Index,” which is used to index devices in the system 300. A determination is made (1056) if the available bandwidth is greater than zero, and thus if there is any available bandwidth that remains due to round-off. If not, (1056-No), the Average Remaining Index is set (1062) equal to n and the method 1050 ends.

If the available bandwidth is greater than zero (1056-Yes), then the available bandwidth is allocated (1058) to device n. The variable n is incremented (1060); if the incremented value of n equals the number of active devices, n is reset to zero, such that n wraps around. The Average Remaining Index is set (1062) equal to n, such that a different device will receive the bandwidth remaining due to round-off during the next iteration of the method 1050. The remaining bandwidth, if any, allocated in the operation 1058 is thus allocated in a round-robin manner for successive iterations of the method 1050.

Bandwidth allocated in the method 1050 may be used, for example, by packets that are queued up after slave devices 320 transmit their queue status reports, but before the beginning of corresponding time slots. The method 1050 thus reduces latency.

Once all bandwidth has been allocated among the active devices during the methods 600, 700, 800, 900, 1000, and/or 1050 (FIGS. 6-10B), the DBA scheduler 304 determines the durations of time slots 208 and/or 210 (FIG. 2B) to be assigned to the devices based on the allocated bandwidth. The DBA scheduler 304 then creates a schedule by ordering the time slots.

FIG. 11A is a flowchart illustrating a method 1100 of generating a transmission schedule in accordance with some embodiments. The method 1100, which is sometimes referred to as a time wheel process, is an example of the operation 416 (FIG. 4) and may be performed by the DBA scheduler 304 of the master device 302 (FIG. 3).

A variable “Slot Index,” which is used to index time slots, is set (1102) equal to zero and the variable n is set (1104) equal to zero. A determination is made (1106) as to whether the device n has been allocated bandwidth. If no (1106-no), the method 1100 jumps to the operation 1112, described below, and no time slot is assigned to the device n. If yes (1106-yes), the Slot Index is associated (1108) with device n, thus assigning the time slot indexed by Slot Index to device n. The Slot Index is then incremented. The variable n is incremented (1110). A determination is made (1112) if n equals the number of active devices. If no (1112-no), the method 1100 has not been completed for every active device and the method 1100 returns to operation 1106. If yes (1112-yes), time slots have been assigned to every active device that was allocated bandwidth.

FIG. 11B is a flowchart illustrating an alternate method 1150 of generating a transmission schedule in accordance with some embodiments. The method 1150, which is also sometimes referred to as a time wheel process, is another example of the operation 416 (FIG. 4) and may be performed by the DBA scheduler 304 of the master device 302 (FIG. 3).

A first time slot, for which the Slot Index equals zero, is associated (1152) with a first device (device 0, i.e., n=0), such that device 0 is assigned the first time slot. The Slot Index is then set to one. The variable n is set (1154) equal to a variable “Scheduling Index,” which is used to index devices. A determination is made (1156) as to whether the device n has been allocated bandwidth and whether n is not equal to zero (“n!=0”). If both conditions are not satisfied (1156-no), the method 1150 skips to the operation 1162, described below, and no time slot is assigned to the device n. If both conditions are satisfied (1156-Yes), the Slot Index is associated (1158) with the device n, such that the device n is assigned the corresponding time slot.

The variable n is incremented (1160). If the incremented value of n equals the number of active devices, n is reset to zero, such that n wraps around. A determination is made (1162) if n equals the Scheduling Index. If no (1162-no), the method 1150 has not been completed for every active device and the method 1150 returns to operation 1156. If yes (1162-yes), the method 1150 has been completed for every active device. The variable n is incremented (1164) and the Scheduling Index is then set (1064) equal to n. As a result, with the exception of the first device, the order in which devices are assigned time slots varies for different beacon periods 202. Varying this order averages out latencies for the various devices, whereas the fixed order of the method 1100 (FIG. 11A) causes average latencies to vary between devices (but in a known manner).

While the method 400 (FIG. 4), including the methods 500, 600, 700, 800, 900, 1000, 1050, 1100, and/or 1150 (FIGS. 5-11B), includes a number of operations that appear to occur in a specific order, it should be apparent that the method 400 can include more or fewer operations, which can be executed serially or in parallel. An order of two or more operations may be changed and two or more operations may be combined into a single operation.

The method 400 allows service level agreements that specify multiple types of bandwidth (e.g., assured bandwidth and peak bandwidth) to be implemented with flexibility. The method 400 honors Quality of Service based on different priority levels while avoiding wasting unused bandwidth. If some devices do not require bandwidth during a time period, other devices may use the unrequired bandwidth.

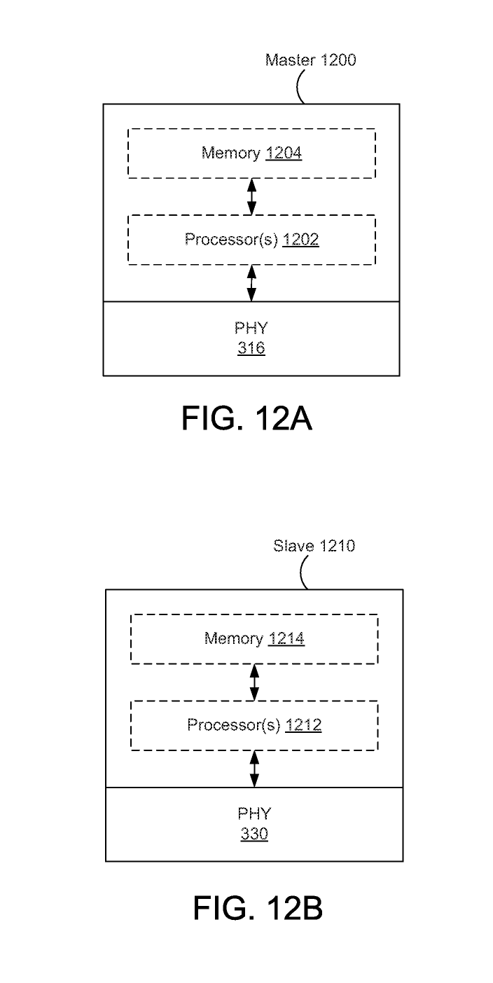

In some embodiments, the TDMA MAC 310 and/or DBA scheduler 304 (FIG. 3) in the master device 302 are implemented in software. FIG. 12A is a block diagram of a master device 1200 that is an example of such a master device 302 in accordance with some embodiments. In the master device 1200, the PHY 316 is coupled to one or more processor cores 1202, which are coupled to memory 1204. In some embodiments, the memory 1204 includes a non-transitory computer-readable medium (e.g., one or more nonvolatile memory elements, such as EPROM, EEPROM, Flash memory, a hard disk drive, and so on) that stores instructions for execution by the one or more processor cores 1202. The instructions include instructions that, when executed by the processor core(s) 1202, cause the master device 1200 to perform all or a portion of the method 400 (FIG. 4), including the methods 500, 600, 700, 800, 900, 1000, 1050, 1100, and/or 1150 (FIGS. 5-11B).

In some embodiments, the TDMA MAC 322 (FIG. 3) in a slave device 320 (FIG. 3) is implemented in software. FIG. 12B is a block diagram of a slave device 1210 that is an example of such a slave device 320 (FIG. 3) in accordance with some embodiments. In the slave device 1210, the PHY 330 is coupled to one or more processor cores 1212, which are coupled to memory 1214. In some embodiments, the memory 1214 includes a non-transitory computer-readable medium (e.g., one or more nonvolatile memory elements, such as EPROM, EEPROM, Flash memory, a hard disk drive, and so on) that stores instructions for execution by the one or more processor cores 1212. The instructions include instructions that, when executed by the processor core(s) 1212, cause the slave device 1210 to transmit during assigned time slots.

While the memories 1204 (FIG. 12A) and 1214 (FIG. 12B) are shown as being separate from respective processor core(s) 1202 and 1212, all or a portion of the memories 1204 and/or 1214 may be embedded in the respective processor cores 1202 and 1212(s). In some embodiments, the processor core(s) 1202 and/or 1212 are implemented in the same integrated circuit as respective PHYs 316 and 330. For example, the PHYs 316 and 330 may be integrated with the respective processor cores(s) 1202 and 1212 in single chips, which may or may not also include the respective memories 1204 and 1214.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of allocating bandwidth in a system comprising a master device coupled to multiple slave devices, the method comprising:
in the master device:
assigning credits to each device of a plurality of devices in the system;
allocating bandwidth among the plurality of devices for high-priority traffic, regardless of the credits;
after allocating bandwidth for high-priority traffic, allocating bandwidth among the plurality of devices based on the credits; and
generating a transmission schedule for the plurality of devices based on the allocated bandwidth.

2. The method of claim 1, further comprising:
before allocating bandwidth based on the credits, reducing the credits assigned to a respective device of the plurality of devices by an amount corresponding to the bandwidth allocated to the respective device for high-priority traffic.

3. The method of claim 1, wherein:
assigning the credits comprises assigning assured credits and peak credits to each device; and
allocating bandwidth among the plurality of devices based on the credits comprises:
allocating bandwidth among the plurality of devices based on the assured credits; and
after allocating bandwidth based on the assured credits, allocating bandwidth among the plurality of devices based on the peak credits.

4. The method of claim 3, further comprising:
reducing the assured credits assigned to a respective device of the plurality of devices by an amount corresponding to the bandwidth allocated to the respective device for high-priority traffic and the bandwidth allocated to the respective device based on the assured credits; and
reducing the peak credits assigned to the respective device by an amount corresponding to the bandwidth allocated to the respective device based on the peak credits.

5. The method of claim 3, further comprising:
after allocating bandwidth based on the peak credits, allocating bandwidth among respective devices having queued traffic for which bandwidth has not been allocated.

6. The method of claim 5, further comprising:
after allocating bandwidth among the respective devices having queued traffic for which bandwidth has not been allocated, dividing remaining bandwidth among the plurality of devices.

7. The method of claim 6, wherein allocating bandwidth among the respective devices having queued traffic for which bandwidth has not been allocated and dividing the remaining bandwidth do not consume assured credits and do not consume peak credits.

8. The method of claim 3, wherein assigning the credits comprises periodically refreshing the assured credits and the peak credits assigned to respective devices of the plurality of devices.

9. The method of claim 8, wherein periodically refreshing the assured credits and the peak credits comprises, for a respective device of the plurality of devices:
defining a first number of assured credits associated with a time period;
defining a second number of peak credits associated with the time period;
during the time period, determining whether a number of assured credits for the respective device is negative;
if the number of assured credits for the respective device is negative, increasing the number of assured credits for the respective device by the first number and setting a number of peak credits for the respective device equal to the second number; and
if the number of assured credits for the respective device is not negative, setting the number of peak credits for the respective device equal to the number of assured credits plus the second number and setting the number of assured credits for the respective device equal to the first number.

10. The method of claim 1, further comprising receiving reports from the plurality of devices reporting on queued traffic, including high-priority traffic;
wherein allocating bandwidth for high-priority traffic and allocating bandwidth based on the credits are performed based on the reports.

11. The method of claim 1, wherein:
the high-priority traffic comprises a first type of high-priority traffic and a second type of high-priority traffic;
allocating bandwidth for high-priority traffic comprises allocating bandwidth for the first type of high-priority traffic, regardless of the credits; and
allocating bandwidth based on the credits comprises allocating bandwidth for the second type of high-priority traffic and for low-priority traffic.

12. The method of claim 11, wherein the first type of high-priority traffic comprises Voice-over-Internet-Protocol (VoIP) traffic.

13. The method of claim 1, wherein generating the transmission schedule comprises assigning a time slot to a respective device of the plurality of devices, wherein the time slot has a duration corresponding to the bandwidth allocated to the respective device.

14. The method of claim 1, further comprising broadcasting the transmission schedule to the plurality of devices.

15. The method of claim 1, further comprising:
before allocating bandwidth for high-priority traffic, allocating bandwidth for overhead associated with operating the system.

16. The method of claim 15, wherein allocating bandwidth for overhead comprises allocating bandwidth for control packets, messages from respective slave devices reporting on queued traffic, and sounding.

17. The method of claim 1, wherein:
the multiple slave devices comprise active slave devices and inactive slave devices; and
the plurality of devices comprises the active slave devices.

18. The method of claim 17, wherein the plurality of devices further comprises the master device.

19. A master device to be coupled to a plurality of slave devices in a system, the master device comprising:
a scheduler to:
assign credits to each device of a plurality of devices in the system;
allocate bandwidth among the plurality of devices for high-priority traffic, regardless of the credits;
allocate bandwidth among the plurality of devices based on the credits, after allocating bandwidth for high-priority traffic; and
generate a transmission schedule for the plurality of devices based on the allocated bandwidth; and
a physical-layer device (PHY) to transmit the transmission schedule.

20. A non-transitory computer-readable storage medium storing one or more programs configured to be executed by a master device in a system comprising the master device and a plurality of slave devices, the one or more programs comprising:
instructions to assign credits to each device of a plurality of devices in the system;
instructions to allocate bandwidth among the plurality of devices for high-priority traffic, regardless of the credits;
instructions to allocate bandwidth among the plurality of devices based on the credits, after allocating bandwidth for high-priority traffic; and
instructions to generate a transmission schedule for the plurality of devices based on the allocated bandwidth.

21. A system comprising a master device coupled to a plurality of slave devices, wherein:
the master device comprises a scheduler to:
assign credits to each device of a plurality of devices in the system;
allocate bandwidth among the plurality of devices for high-priority traffic, regardless of the credits;
allocate bandwidth among the plurality of devices based on the credits, after allocating bandwidth for high-priority traffic; and
generate a transmission schedule for the plurality of devices based on the allocated bandwidth;
the master device further comprises a physical-layer device (PHY) to transmit the transmission schedule to the plurality of slave devices; and
the plurality of slave devices is configured to transmit in accordance with the transmission schedule.
